(19) United States
(12) Patent Application Publication
(10) Pub. No.: US 2017/0053310 A1
(43) Pub. Date: Feb. 23, 2017

(54) Systems and Methods for User Optimized Predictive Services

(71) Applicant: Andrew Joseph Farrell, Orlando, FL (US)

(72) Inventor: Andrew Joseph Farrell, Orlando, FL (US)

(21) Appl. No.: 15/238,388

(22) Filed: Aug. 16, 2016

Related U.S. Application Data
(60) Provisional application No. 62/205,799, filed on Aug. 17, 2015.

(51) Int. Cl. G06Q 30/02; G06Q 30/06

(52) U.S. Cl. CPC G06Q 30/0255; G06Q 30/0631

(57) ABSTRACT

In one described system, a system receives information comprising user attributes from one or more key areas of user behavior, user preferences, and/or user opinion and positioning to derive an optimized predictive service for such user in relation to a particular good or service, or a particular category of good or service.

In another described system, a system utilizes the predictive service and combines it with a user selected matching ratio, thus allowing the user to view an updated recommendation based on a comparison with similar users matched by one or more key areas of user behavior, user preferences, and/or user opinion and positioning.

This type of system describes what we are calling Predictive Services.

This application claims priority of provisional application No. 62/205,799 which was filed on Aug. 17, 2015. Submitted and invented by Andrew Joseph Farrell

### DESCRIPTION

I. Field

The present invention generally relates to technology platforms, services, and methods for calculating and providing predictive services for items and/or categories for users.

II. Background

Many advertising and sales technology sites and apps today may include some element of suggestive services, essentially recommending a particular item to a user, based primarily on previous user purchases, user browsing, and combining either or both of those components with either keyword searching or similar purchase or browsing behavior from unrelated users.

This type of system has some functional purposes, but does not provide a truly predictive service because it does not utilize many more relevant facets of user variables which may be available.

Thus, further improvements in technology platforms and methods of allowing the implementation of truly predictive services are desirable.

### SUMMARY OF THE INVENTION

One aspect of the invention enables a system which combines multiple elements of user information to optimize and determine a truly predictive element for a user relating to a particular good or service, or a particular category of good or service.

Another aspect of the present invention is a technology platform for providing a rating or recommendation on either an unselected item or category recommendation for a particular user, or a particular item or category for which the user has requested such a rating or recommendation upon selection.

Yet another aspect of the present invention is a method for implementing such predictive services in a user comparison matching system, such that a user may select the degree of matching to get applicable recommendations based on similar users.

The Summary is neither intended nor should it be construed as being representative of the full extent and scope of the present invention.

### BRIEF DESCRIPTION OF THE DRAWINGS

FIG. 1—Illustration of multiple user variables used in combination to determine the User Behavior element of a predictive service for a particular category or item

FIG. 2—Illustration of multiple user variables used in combination to determine the User Preference element of a predictive service for a particular category or item

FIG. 3—Illustration of multiple user variables used in combination to determine the User Opinion element of a predictive service for a particular category or item

FIG. 4—Illustration of multiple elements being utilized in combination to determine a predictive service for a particular item or category

FIG. 5—Illustration of utilization of multiple user comparison elements, at user requested alignment, to determine a predictive service for a particular item or category

The images in the drawings are conventionally simplified for illustrative purposes and are not depicted to scale.

The drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

### DETAILED DESCRIPTION OF THE PREFERRED EMBODIMENT

Embodiments of the present invention are generally directed to a technology platform and method for predictive services, which would use components or elements of the processes described, or some variation of such processes in myriad combinations.

One embodiment of the invention enables a system which combines multiple elements of user information to optimize and determine a truly predictive element to what that user may be interested in relating to a particular good or service, or a particular category of good or service.

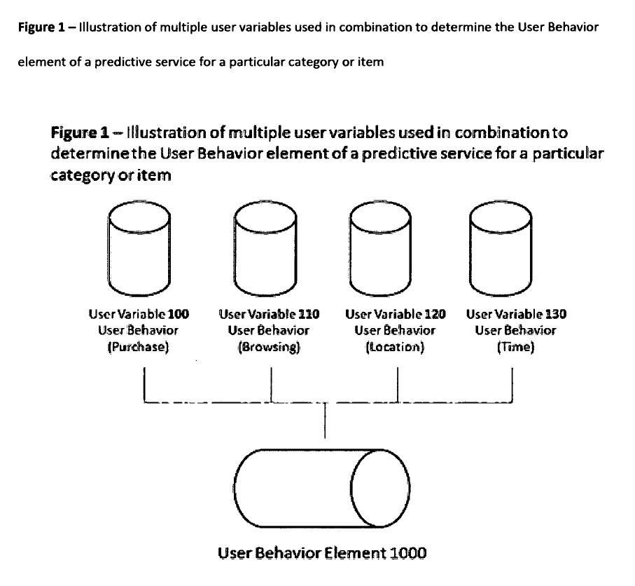

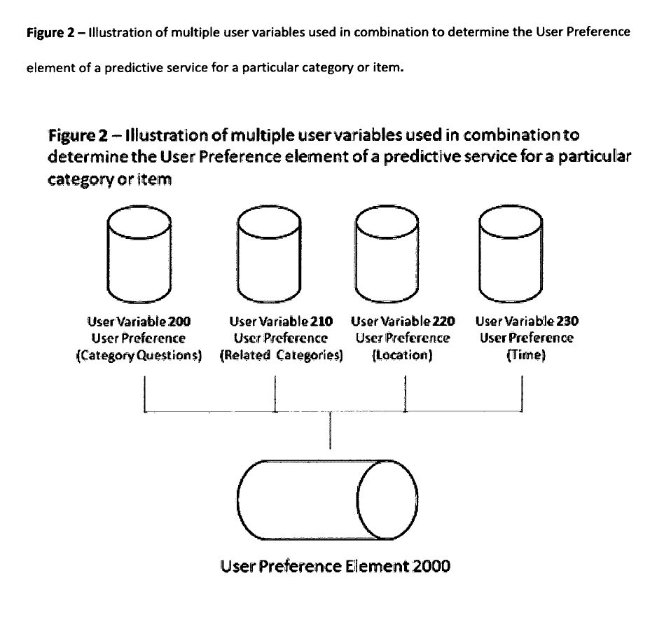

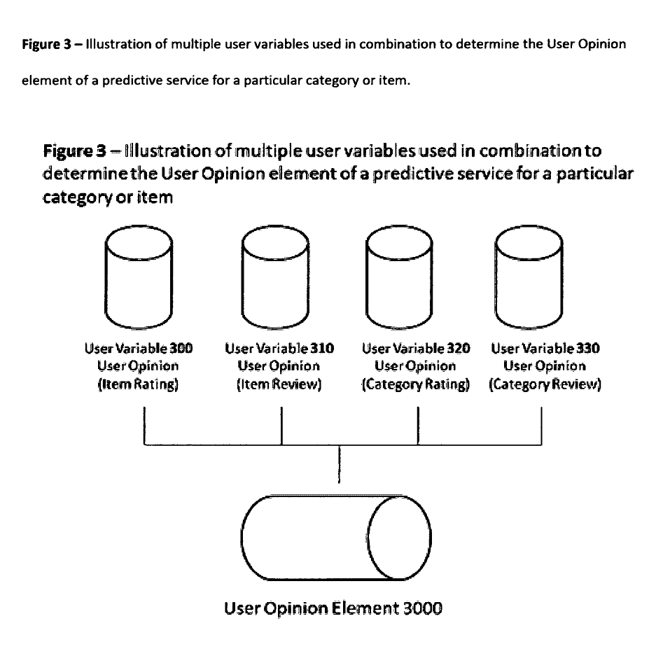

The 3 elements are detailed as the following:
1. User Behavior (purchase, browsing, location, and time). See FIG. 1
2. User Preferences (based on user responses to questions, surveys, etc. about a particular category of interest) See FIG. 2
3. User Opinion and Positioning (base on a formal user review of a related good or service, or an informal review by user on various social platforms or separate mechanisms or platforms) See FIG. 3

By combining these 3 elements into a comprehensive data based framework, we may then imply much more about the user which may be utilized for truly optimized Predictive Services of a good of service that a user may have a higher level of interest in.

Embodiments of the invention can comprise one or more computer programs that may include the functions described herein and illustrated. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention.

FIG. 1 is an Illustration of multiple user variables used in combination to determine the User Behavior element of a predictive service for a particular category or item. In this example, User variable 100 (User Behavior—Purchase), User Variable 110 (User Behavior—Browsing), User variable 120 (User Behavior—Location), and User variable 130 (User Behavior—Time), are used in any combination to determine the User Behavior element 1000 which will be used in the predictive service as applicable.

FIG. 2 is an Illustration of multiple user variables used in combination to determine the User Preference element of a predictive service for a particular category or item. In this example, User variable 200 (User Preference—Category Questions), User Variable 210 (User Preference—Related Categories), User variable 220 (User Preference—Location), and User variable 230 (User Preference—Time), are used in any combination to determine the User Preference element 2000 which will be used in the predictive service as applicable.

FIG. 3 is an Illustration of multiple user variables used in combination to determine the User Opinion element of a predictive service for a particular category or item. In this example, User variable 300 (User Opinion—Item Rating), User Variable 310 (User Opinion—Item Review), User variable 3220 (User Opinion—Category Rating), and User variable 330 (User Opinion—Category Review), are used in any combination to determine the User Opinion element 3000 which will be used in the predictive service as applicable.

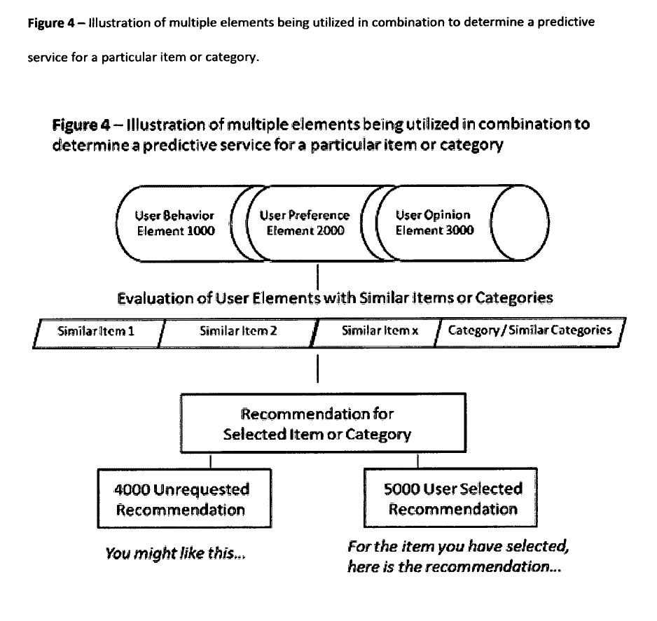

FIG. 4 is an Illustration of multiple elements being utilized in combination to determine a predictive service for a particular item or category. In this example, User Behavior Element 1000, User Preference Element 2000, and User pinion Element 3000 are utilized in some combination in the calculation of a predictive service for a particular item or category. Utilizing such elements along with similar items, a particular category, and/or similar categories, the system derives a recommendation for the user. Such recommendation may for either 4000 An Unrequested Recommendation or for 5000 A User Selected Recommendation.

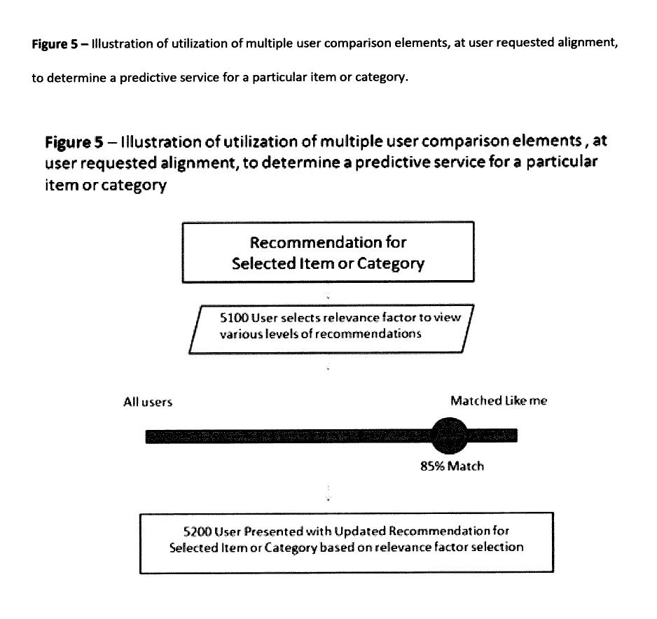

FIG. 5 is an Illustration of utilization of multiple user comparison elements, at a user selected requested alignment, to determine a predictive service for a particular item or category. In this example, the user selects a relevance factor 5100 which will align the recommendation to a particular matching comparison to separate users. The user is then presented with an Updated Recommendation for a Selected Item or Category 5200 based on the relevance factor selection.

1. A system for calculating user predictive services, comprising:
A set of user variables, acquired through various methods, which are combined to formulate key elements of the predictive service,
A process combining some or all of the key elements in an analysis of particular items or categories of goods or services
A presentation or recommendation based upon the analysis

2. The system of claim 1, wherein the presentation or recommendation is an unrequested recommendation.

3. The system of claim 1, wherein the presentation or recommendation is a user selected recommendation.

4. A method for displaying the presentation or recommendation to the user by utilizing a matching relevance factor selection.
